(19) United States
(12) Patent Application Publication
(10) Pub. No.: US 2015/0351544 A1
(43) Pub. Date: Dec. 10, 2015

(54) WALL BRACKET FOR A FLAT SCREEN

(71) Applicant: Joachim PETERS, March (DE)

(72) Inventor: Joachim PETERS, March (DE)

(21) Appl. No.: 14/760,015

(22) PCT Filed: Jan. 7, 2014
(86) PCT No.: PCT/DE2014/100003

§ 371 Date: Jul. 23, 2015

(30) Foreign Application Priority Data
Jan. 10, 2013 (DE) 20 2013 000 202.6

(51) Int. Cl. A47B 97/00; F16M 13/02; F16B 45/00

(52) U.S. Cl. CPC A47B 97/001; F16B 45/00; F16M 13/022

(57) ABSTRACT

Proposed is a wall bracket for a flat screen having a length-variable first bar (2, 22), with a fastening device (3) which fastens the first bar (2, 22) in a substantially horizontal orientation to at least one wall (7, 27, 28), with at least two hooks (5, 25) which can be fastened on the rear side of the flat screen (14) and which are mountable on the first bar (2, 22), with a closure (16) for the hooks (5).

The invention relates to a wall bracket for a flat screen.

Such wall brackets normally exhibit a first plate that is to be arranged on the rear side of the flat screen and a second plate that is to be arranged on a wall. Both plates are connected to each other by means of a swivelling arm or at least a folding arm. In this manner the angle formed by the flat screen with the wall can be adjusted. It has proven to be disadvantageous that such wall brackets are awkward to manufacture and to install.

The object of the invention is to provide a wall bracket for flat screens that consists of only a few components and is easy to install.

This object is achieved by a wall bracket having the features of claim 1. The wall bracket is characterised in that it has a length-variable first bar that is fastened in a substantially horizontal orientation to one or two walls and at least two hooks that are fastened to the rear side of the flat screen and are mounted on the first bar. The hooks are equipped with a closure that in the closed position transforms the hook into an eye or ring. This prevents the hooks from detaching from the first bar in the event of an unintended force acting on the flat screen and the flat screen from falling to the ground.

Housings of flat screens are normally equipped with threaded bushings on the rear side. The rear side of the housing of flat screens may furthermore be provided with recesses or through openings. The hooks can be fastened to the threaded bushings, recesses or through openings. For example, a screw or plug connection between the housing of the flat screen and the hooks of the wall bracket is suitable for this purpose. The hooks may furthermore be designed as double hooks with two hook parts, so that one hook part is mountable on the housing of the flat screen and the other hook part on the bar.

The fastening device is designed in such a way that with it the first bar can be fastened either to one wall or to two walls, whereby the two walls form an angle of less than 180°. The wall bracket thereby allows not only the arrangement of a flat screen on a level wall but also the mounting of a flat screen in a corner bounded by two walls. The fastening device can support the first bar at both its ends or in sections at a distance from the ends of the first bar. If the wall bracket is to be fastened to one wall, the sections in which the fastening device supports the first bar can essentially be chosen freely. If the wall bracket is to be fastened to two walls, the fastening device supports the first bar preferably at its ends.

The first bar is variable in its length and can thus be adjusted to the place of installation and to the size of the flat screen. If the wall bracket is to be fastened in a corner bounded by two walls, the first bar can be set exactly in its length to the desired orientation of the flat screen.

To install the wall bracket, the fastening device is first fastened to the wall or walls, taking into consideration that the first bar arranged with the fastening device on the wall or walls is oriented substantially horizontally. The first bar is then adjusted in its length to the place of installation and the flat screen to be fastened and is arranged on the fastening device. The hooks are fastened to the rear side of the flat screen. The flat screen is mounted on the first bar by means of the hooks. The hooks are closed and secured on the first bar by means of the closure. After installation the flat screen can be turned around the first bar if this is necessary for cleaning purposes or so that mains connections, external data carriers or further devices can be connected and disconnected.

The wall bracket according to the invention is thus composed of only a few components. It is also quick and easy to install.

According to an advantageous embodiment of the invention, the first bar is a telescopic bar.

According to a further advantageous embodiment of the invention, the fastening device exhibits at least two pipe clips. The pipe clips may be one-part or two-part pipe clips. In their closed position the pipe clips enclose the first bar. In order to mount the first bar on the wall in a substantially horizontal orientation at least two pipe clips are needed holding the first bar in two different sections. The pipe clips are equipped for example with a connecting thread to enable them to be fastened to a wall. The connecting thread can for example be part of a nut that is permanently connected to the pipe clip. A threaded rod or headless pin is screwed into the connecting thread. The threaded rod or headless pin is fastened to a wall. The pipe clips can be made of plastic or metal. In the closed position of the pipe clips the first bar is secured in such a way that it cannot detach undesirably from the fastening device.

According to a further advantageous embodiment of the invention, the fastening device exhibits two bar receivers in which the first bar is mountable with its ends. Each of these bar receivers forms a U-shaped profile. This profile surrounds the first bar from below and from the sides. The profile is open upwards, so that the first bar can be introduced into the profile from above. If necessary, the profile can be closed on the side open to the top after the bar has been inserted. Such profiles are known from the hanging of clothes rails in wardrobes. For the arrangement of the bar receivers in a corner formed by two walls, each of the two bar receivers is arranged in a base allowing the inclination of the bar receiver to the wall to be adjusted. In this arrangement the first bar is arranged with each end in one of the bar receivers. One front side of each bar is received in a bar receiver.

According to a further advantageous embodiment of the invention, the wall bracket comprises a second length-variable bar that can be fastened to the rear side of the flat screen and is supported by a wall. The bar arranged on the rear side of the flat screen advantageously protrudes substantially vertically backwards from the rear side of the flat screen. At the flat screen mounted on the bar it is located below the bar and the hooks. The angle of inclination of the flat screen mounted on the bar can be adjusted along the length of the second bar. The second bar is for example glued on the rear side of the flat screen to the housing thereof.

According to a further advantageous embodiment of the invention, the first bar exhibits a round cross-section.

According to a further advantageous embodiment of the invention, the diameter of the bar is between 1.0 cm and 2.5 cm, particularly preferably between 1.5 cm and 2.5 cm. In a particularly preferred model embodiment the diameter is 1.9 cm.

According to a further advantageous embodiment of the invention, the length of the bar is at least 25 cm, particularly preferably at least 28 cm.

According to a further advantageous embodiment of the invention, the length of the bar is not more than 80 cm, particularly preferably at least 50 cm.

According to a further advantageous embodiment of the invention, a pin or splint that is connected to the hook by means of two recesses is provided as closure for each of the hooks. Alternatively, the hook can be designed as a spring hook.

Further advantages and advantageous embodiments of the invention can be obtained from the following description, the drawing and the claims.

### DRAWING

The drawing shows two model embodiments of the wall bracket according to the invention. Illustrations:

FIG. 1 Side view of a first model embodiment of a wall bracket with flat screen arranged on a wall

FIG. 2 Section of a first bar of the wall bracket according to FIG. 1 with a fastening device and hook

FIG. 3 Side view of a first bar with fastening device of the wall bracket according to FIG. 1

FIG. 4 Side view of a hook of the wall bracket according to FIG. 1

FIG. 5 Side view of a second bar of the wall bracket according to FIG. 1

FIG. 6 View from above of the wall bracket with flat screen according to FIG. 1

FIG. 7 View from above of a second model embodiment of a wall bracket which is arranged on two walls bounding a corner.

### DESCRIPTION OF THE MODEL EMBODIMENTS

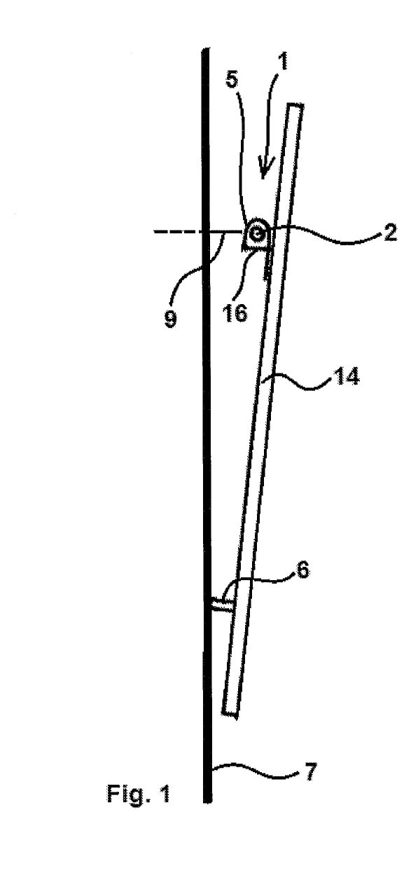

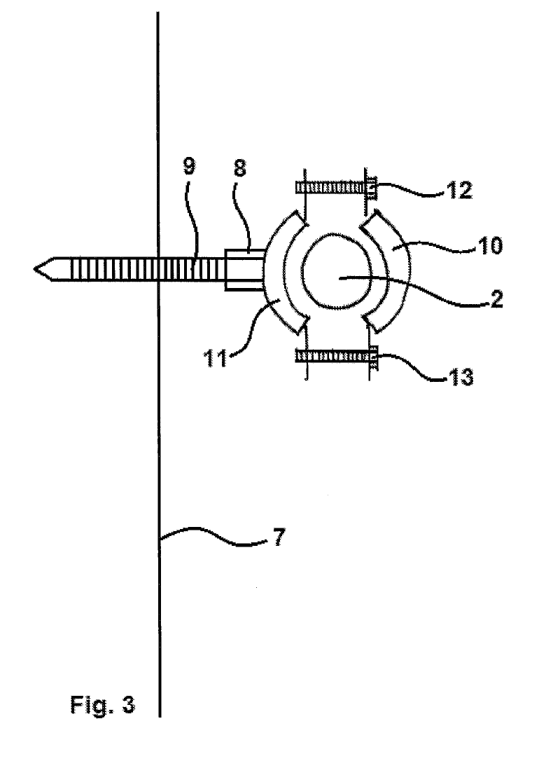

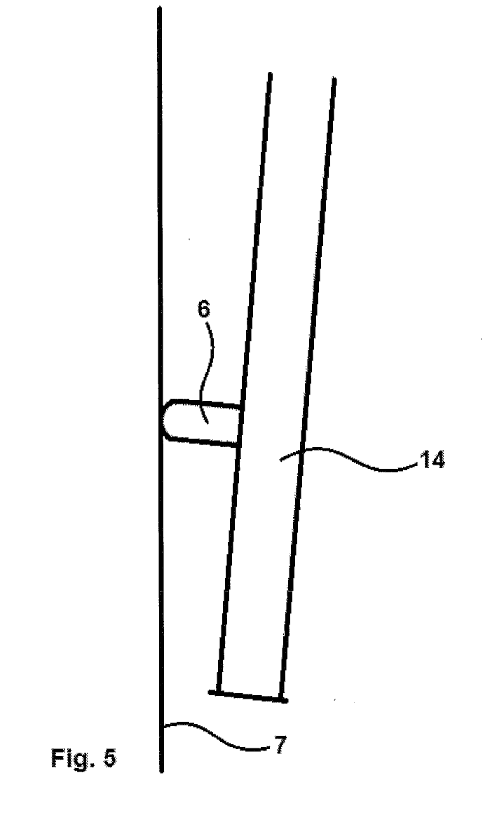

FIGS. 1 to 6 represent a first model embodiment of a wall bracket 1. The wall bracket 1 exhibits a length-variable first bar 2, a fastening device 3 with two pipe clips 4, two hooks 5 and a second length-variable bar 6, whereby the first length-variable bar 2 is fastened to a wall 7 by means of the fastening device 3. To that end the two pipe clips 4 are each equipped with a connecting thread 8 and a threaded rod 9. The threaded rod 9 is anchored in the wall 7. This is illustrated in FIG. 3. The pipe clips 4 are both identical. They are two-part pipe clips. The two parts 10, 11 of each of the pipe clips 4 are braced with one another by means of screws 12, 13 and thereby pressed against the bar 2, so that the bar 2 is thereby clamped in the pipe clips 4.

In FIG. 1 the pipe clips 4 of the fastening device 3 are covered by the hook 5 and therefore not visible.

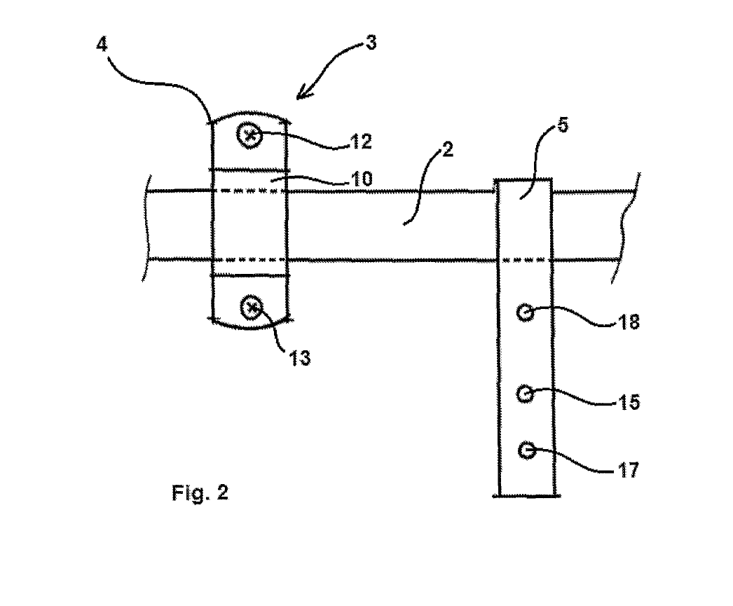

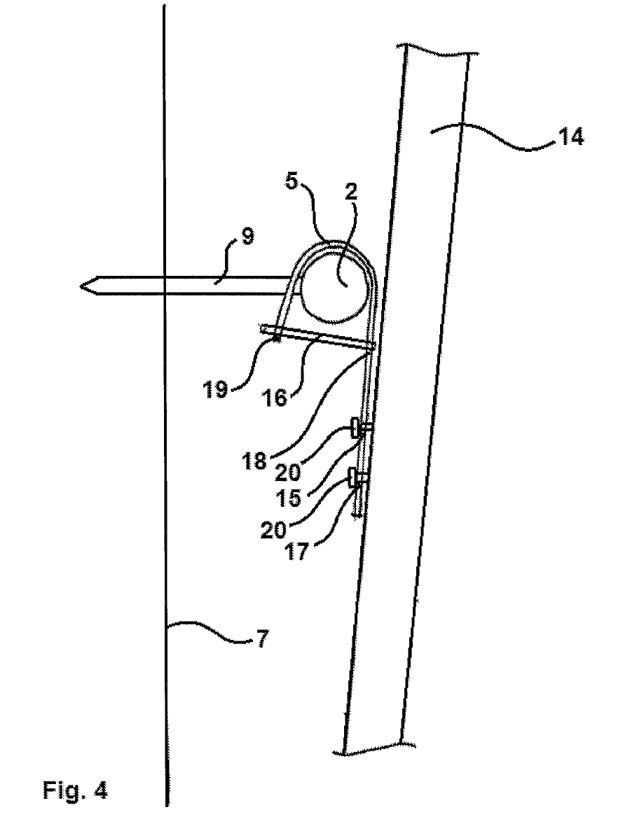

FIG. 2 shows a section of the first bar 2 with a pipe clip 4 and a hook 5. This is a top view of the side facing the rear side of the flat screen. The flat screen is not illustrated in this view because otherwise it would cover the bar 2, the pipe clip 4 and the hook 5. In this illustration can be seen a part 10 of the two-part pipe clip 4 and two screws 12 and 13 that connect the part 10 with a second part 11 illustrated in FIG. 3 of the pipe clip 4. The hook 5 is also illustrated in FIG. 2. The hook 5 is equipped with a first through opening 15, a second through opening 17 and a third through opening 18. The hook further exhibits a fourth through opening 19 which is visible in FIG. 4. The first and second through openings 15, 17 are used to fasten the hook 5 to the rear side of a flat screen 14. This fastening is also illustrated in a side view in FIG. 4. Screws 20 are used for fastening. These are screwed into threaded bushings on the rear side of the flat screen 14. The third through opening 18 and the fourth through opening 19 serve as receivers for a pin 16 that secures the hook 5 to the first bar 2. This is illustrated in FIG. 4.

For the sake of clarity, FIG. 4 only shows the threaded rod 9 of the fastening device. The pipe clips 4 and the connecting thread 9 are not illustrated. They are in any case at least partially hidden by the hook 5 shown in FIG. 4.

A second length-variable bar 6 is fastened below the hook 5 on the rear side of the flat screen and protrudes backwards from the rear side of the flat screen 14 towards the wall 7. With this second bar the flat screen 14 is supported in its lower portion on the wall 7. The inclination of the flat screen can be adjusted by the length of the second bar.

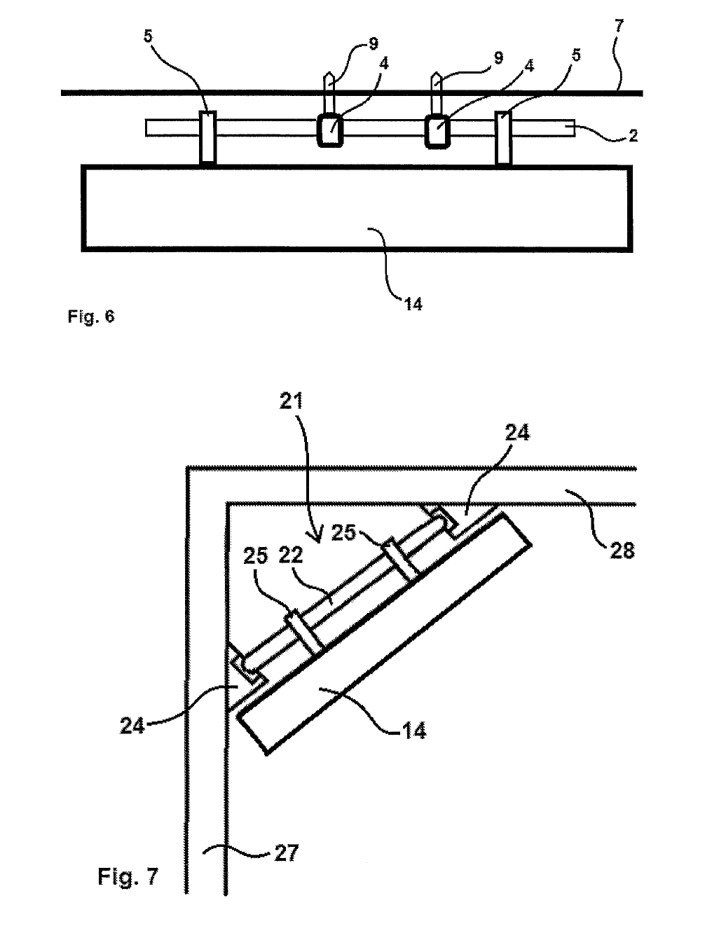

FIG. 6 shows the wall bracket 1 in a view from above. In this view the first bar 2, the two pipe clips 4 of the fastening device 3, the hooks 5, the wall 7 and the flat screen 14 are visible.

FIG. 7 shows a second model embodiment of a wall bracket 21 in a view from above. Like the first model embodiment it exhibits a first length-variable bar 22, a fastening device and two hooks 25. The difference to the first model embodiment consists in the fastening of the wall bracket 21 to the walls 27, 28, which form a corner. In the second model embodiment the two walls 27, 28 form an angle of 90°. The fastening device is equipped with two bar receivers 24 that each surround one end of the bar 22 and that are each arranged on one of the two walls 27, 28. Exactly as in the first model embodiment the two hooks 25 are fastened to the rear side of a flat screen 14 and mounted on the bar 22.

All features of the invention can be material to the invention both individually and in any combination.

### REFERENCE NUMBERS

1 Wall bracket
2 First length-variable bar
3 Fastening device
4 Pipe clip
5 Hook
6 Second length-variable bar
7 Wall
8 Connecting thread
9 Threaded rod
10 Part of the pipe clip
11 Part of the pipe clip
12 Screw
13 Screw
14 Flat screen
15 First through opening
16 Pin
17 Second through opening
18 Third through opening
19 Fourth through opening
20 Screw
21 Wall bracket
22 First length-variable bar
23
24 Bar receiver
25 Hook
26
27 Wall
28 Wall

1. Wall bracket for a flat screen with a length-variable first bar (2, 22),
with a fastening device (3) which fastens the first bar (2, 22) in a substantially horizontal orientation to at least one wall (7, 27, 28), with at least two hooks (5, 25) which can be fastened on the rear side of the flat screen (14) and which are mountable on the first bar (2, 22), with a closure (16) for the hooks (5).

2. Wall bracket according to claim 1, wherein the first bar (2, 22) is a telescopic bar.

3. Wall bracket according to claim 1, wherein the fastening device (3) exhibits at least two pipe clips (4).

4. Wall bracket according to claim 1, wherein the fastening device exhibits two bar receivers (24) in which the first bar (22) is mountable with its ends.

5. Wall bracket according to claim 1, wherein it exhibits a length-variable second bar (6) which can be fastened on the rear side of the flat screen (14) and is supported on a wall (7).

6. Wall bracket according to claim 1, wherein each hook (5) exhibits two through openings (18, 19), wherein the hook (5) is equipped with a pin (16) or splint as closure, and wherein the pin (16) or splint is connectable in the hook (5) by means of the two through openings (18, 19).
